(19) United States
(12) Patent Application Publication
(10) Pub. No.: US 2020/0293806 A1
(43) Pub. Date: Sep. 17, 2020

(54) CAMERA SYSTEM AND FACILITY

(71) Applicant: CANON KABUSHIKI KAISHA, Tokyo (JP)

(72) Inventors: Takahiro Sato, Ebina-shi (JP); Yasushi Koyama, Kamakura-shi (JP); Takeaki Itsuji, Hiratsuka-shi (JP); Toshifumi Yoshioka, Hiratsuka-shi (JP); Eiichi Takami, Chigasaki-shi (JP); Rei Kurashima, Yokohama-shi (JP); Jun Iba, Yokohama-shi (JP); Noriyuki Kaifu, Atsugi-shi (JP)

(21) Appl. No.: 16/815,190

(22) Filed: Mar. 11, 2020

(30) Foreign Application Priority Data
Mar. 14, 2019 (JP) 2019-047788
Feb. 27, 2020 (JP) 2020-032193

(51) Int. Cl. G06K 9/20; G06K 9/00; H04N 5/247; G06K 9/03

(52) U.S. Cl. CPC G06K 9/2018; G06K 9/03; H04N 5/247; G06K 9/00664

(57) ABSTRACT

A camera system is provided. The camera system is arranged to form a part of a monitoring system arranged in a place of a facility where an inspection object lines up. The camera system comprises an imaging system configured to acquire an image formed by a terahertz wave reflected by the inspection object.

### BACKGROUND OF THE INVENTION

### Field of the Invention

The present invention relates to a camera system and a facility.

### Description of the Related Art

An inspection technique using a terahertz wave is known. The terahertz wave can be defined as an electromagnetic wave having a frequency of 30 (inclusive) GHz to 30 THz (inclusive). Japanese Patent Laid-Open No. 2004-286716 discloses a method of inspecting a prohibited drug such as a narcotic drug enclosed in a sealed letter. In this method, a characteristic absorption spectrum that a prohibited drug such as a narcotic drug has in the terahertz band is used to identify a substance in a sealed letter without breaking the seal.

### SUMMARY OF THE INVENTION

Recently, dangerous items such as knives being taken into a railroad coach through a railroad station is a serious problem from the viewpoint of crime prevention. There is strong demand for a technique of detecting such a dangerous item.

Some embodiments of the present invention provide a technique advantageous in improving crime prevention by a camera system installed in a facility.

According to some embodiments, a camera system arranged to form a part of a monitoring system arranged in a place of a facility, where an inspection object lines up, comprising an imaging system configured to acquire an image formed by a terahertz wave reflected by the inspection object, is provided.

According to some other embodiments, a facility including a camera system, wherein the camera system arranged to form a part of a monitoring system arranged in a place of a facility, where an inspection object lines up, comprises an imaging system configured to acquire an image formed by a terahertz wave reflected by the inspection object, is provided.

Further features of the present invention will become apparent from the following description of exemplary embodiments (with reference to the attached drawings).

### BRIEF DESCRIPTION OF THE DRAWINGS

FIGS. 1A and 1B are views showing an arrangement example of a ticket gate machine in which an imaging system included in a camera system according to an embodiment is arranged;

FIGS. 2A and 2B are views showing a modification of the ticket gate machine shown in FIGS. 1A and 1B;

FIGS. 3A and 3B are views showing an arrangement example of a partition in which the imaging system included in the camera system according to the embodiment is arranged;

FIGS. 4A to 4C are views showing a modification of the partition shown in FIGS. 3A and 3B;

FIGS. 5A and 5B are views showing an arrangement example of an escalator in which the imaging system included in the camera system according to the embodiment is arranged;

FIGS. 6A and 6B are views showing an arrangement example of a staircase in which the imaging system included in the camera system according to the embodiment is arranged;

FIGS. 7A and 7B are views showing an anangement example of a passage in which the imaging system included in the camera system according to the embodiment is arranged;

FIG. 8 is a view showing an anangement example of a station in which the imaging system included in the camera system according to the embodiment is arranged;

FIG. 9 is a view showing an anangement example when the camera system according to the embodiment and a railroad coach monitor an inspection object;

FIG. 10 is a flowchart showing an operation example of the camera system according to the embodiment;

FIG. 11 is a flowchart showing an operation example of the camera system according to the embodiment;

FIG. 12 is a flowchart showing an operation example of the camera system according to the embodiment; and

FIG. 13 is a flowchart showing an operation example of the camera system according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

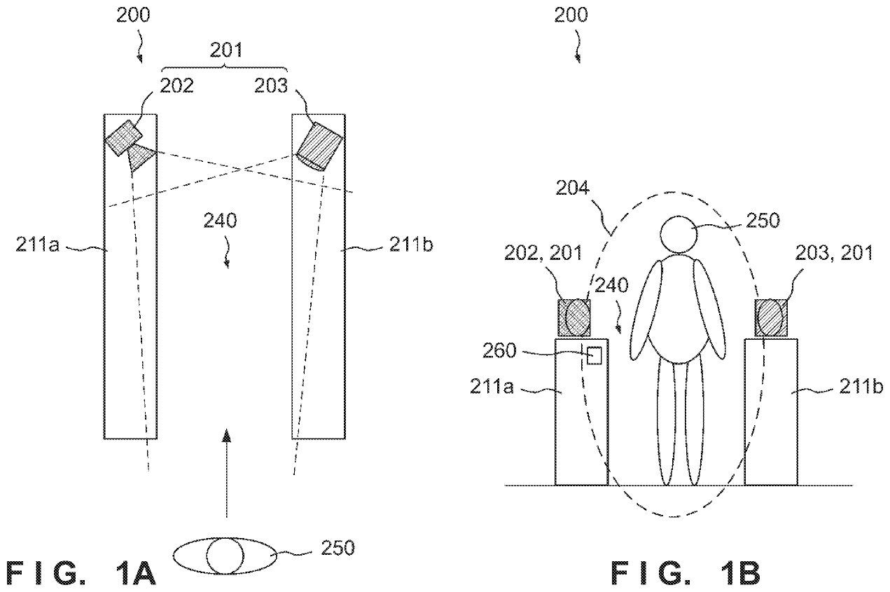

A camera system 200 according to some embodiments of the present invention will be described with reference to FIGS. 1A to 13. The camera system 200 according to this embodiment is installed in a facility. Examples of the facility are terminals such as a railroad station and an airport, a commercial facility, and an amusement facility. The camera system 200 according to this embodiment is installed in a structure of a railroad station or the like. Structures of a station include a station building in which a ticket gate, a ticket office, a waiting room, and the like are arranged, a platform at which a railroad coach arrives, a passage that connects the station building and the platform, and the like. Here, the passage can be not only a flat passage but also a place where passengers pass, such as a staircase, an escalator, or an elevator. In addition, a railroad coach is an example of a movable body. If the facility is an airport, the movable body is, for example, an airplane. The camera system 200 according to this embodiment can be a camera system arranged so as to form a part of the monitoring system of a station.

The camera system 200 includes an imaging system 201 configured to acquire an image formed by a terahertz wave reflected by an inspection object 250. The imaging system 201 can include at least one illumination unit 202 configured to irradiate a terahertz wave, and at least one camera 203 configured to acquire an image formed by the terahertz wave. The illumination unit 202 is also referred to as the irradiation unit. To discriminate a plurality of illumination units 202 and a plurality of cameras 203 in the following explanation, a suffix is added to each reference numeral, like an illumination unit 202“a” and a camera 203“a”. If the illumination units and the cameras need not be discriminated, they are expressed simply as “illumination unit 202” and “camera 203”. This also applies to other constituent elements.

In this embodiment, the camera 203 that detects a terahertz wave is of a type called active camera, and can be used in combination with the illumination unit 202. However, the camera is not limited to this, and may be a camera of a passive type. In this case, without illuminating the inspection object 250 with a terahertz wave irradiated from the illumination unit 202, and an image can be acquired by a terahertz wave radiated from the inspection object 250.

The imaging system 201 can be arranged to capture the inspection object 250 that uses the station. The inspection object 250 is normally a person but may be an animal other than a person or a robot. A terahertz wave passes through a fabric, a leather, and the like. For this reason, a processor (for example, a control system 310 to be described later) (not shown) connected to the camera system 200 can detect a dangerous item such as a firearm, a cutting tool, or an explosive based on an image provided from the imaging system 201 of the camera system 200.

FIGS. 1A and 1B are a plan view and a front view, respectively, showing an arrangement example of a ticket gate machine 211 in which the imaging system 201 included in the camera system 200 according to the present invention is arranged. The ticket gate machine 211 is installed in a ticket gate of a station, and separates the inside of the ticket gate and the outside of the ticket gate. Here, the inside of the ticket gate can be an area that needs a ticket such as a platform ticket or a boarding ticket to enter. The ticket gate machine 211 may be an automatic ticket gate machine. The imaging system 201 is arranged to acquire an image of the inspection object 250 that passes through a passage 240 of the ticket gate machine 211. For example, the imaging system 201 may acquire the image of the inspection object 250 entering from the outside of the ticket gate to the inside of the ticket gate. A description will be made below assuming that the inspection object 250 passes from the outside of the ticket gate to the inside of the ticket gate in the direction of an arrow shown in FIG. 1A.

In the arrangement shown in FIGS. 1A and 1B, the ticket gate machine 211 includes a ticket gate machine 211a and a ticket gate machine 211b, which are arranged to face each other across the passage. That is, the width and length of the passage 240 of the ticket gate machine 211 can be decided by the ticket gate machine 211a and the ticket gate machine 211b. The imaging system 201 includes the illumination unit 202 arranged on the ticket gate machine 211a, and the camera 203 arranged on the ticket gate machine 211b. A terahertz wave irradiated from the illumination unit 202 can be specularly reflected by the inspection object 250 such as a person. For this reason, when the illumination unit 202 and the camera 203 are arranged on the ticket gate machine 211a and the ticket gate machine 211b, which face each other across the passage 240, respectively, the terahertz wave irradiated from the illumination unit 202 is readily reflected by the inspection object 250 and detected by the camera 203.

As shown in FIG. 1B, the illumination unit 202 can use a range 204 of almost the whole passage 240 as an irradiation range. The spread of the terahertz wave irradiated from the illumination unit 202 can be adjusted by using a lens or the like. In addition, the terahertz wave is reflected by a metal or the like. Hence, the inspection object 250 is illuminated even near the lower portion of the ticket gate machine 211a because the terahertz wave is reflected by the side surface of the ticket gate machine 211b. Furthermore, to effectively use the reflection of the terahertz wave by each side surface of the ticket gate machine 211 on the side of the passage 240, the illumination unit 202 and the camera 203 may be arranged near the end portion of the ticket gate machine 211 on the opposite side of the directions of the optical axes of the illumination unit 202 and the camera 203, as shown in FIG. 1A. That is, the illumination unit 202 and the camera 203 configured to capture the outer side of the ticket gate from the ticket gate machine 211 may be arranged near the end portion of the ticket gate machine 211 on the inner side of the ticket gate.

The arrangement of the illumination unit 202 and the camera 203 is not limited to the above-described arrangement. For example, the illumination unit 202 and the camera 203 may be arranged on the ticket gate machine 211a. Alternatively, for example, the illumination unit 202 and the camera 203 may be arranged near the center of the ticket gate machine 211, or may be arranged near the end portion on the outer side of the ticket gate in FIG. 1A. For one camera 203, the illumination unit 202 may be formed by a plurality of illumination devices. For example, the illumination unit 202 may be formed by a plurality of illumination devices whose terahertz wave irradiation directions are different. In addition, the illumination unit 202 and the camera 203 may be fixed to the ticket gate machine 211 in an immovable state, or may be arranged, for example, rotatably in accordance with the movement of the inspection object 250.

If the imaging system 201 of the camera system 200 is used as a surveillance camera, in some cases, post-processing such as image processing by a processor (not shown) at the subsequent stage of the imaging system 201 of the camera system 200 is facilitated by capturing the person who is the inspection object 250 one by one. The ticket gate machine 211 passes the person who is the inspection object 250 one by one at a high possibility. Hence, when the imaging system 201 is arranged in the ticket gate machine 211, the load of post-processing such as image processing can be suppressed. That is, the imaging system 201 can be arranged in a place where the inspection object 250 lines up. In addition, the time needed for the person that is the inspection object 250 to pass through the ticket gate machine 211 is about 1 sec. However, the imaging system 201 can acquire an image formed by a terahertz wave at a frame rate of 50 fps or more. For this reason, it is possible to perform capture one inspection object 250 at plurality of times. In the plurality of times of image capturing, the inspection object 250 may be captured wholly or may be captured only partially.

The imaging system 201 of the camera system 200 may include a sensor 260 configured to detect that the inspection object 250 approaches. For example, the ticket gate machine 211 may be provided with the sensor 260, as shown in FIG. 1B. Alternatively, for example, the sensor 260 may be added to the illumination unit 202 or the camera 203. The illumination unit 202 is controlled based on the output of the sensor 260. For example, the illumination unit 202 may start irradiating the terahertz wave in accordance with detection of the inspection object 250 by the sensor 260. This can suppress the power consumed by the imaging system 201.

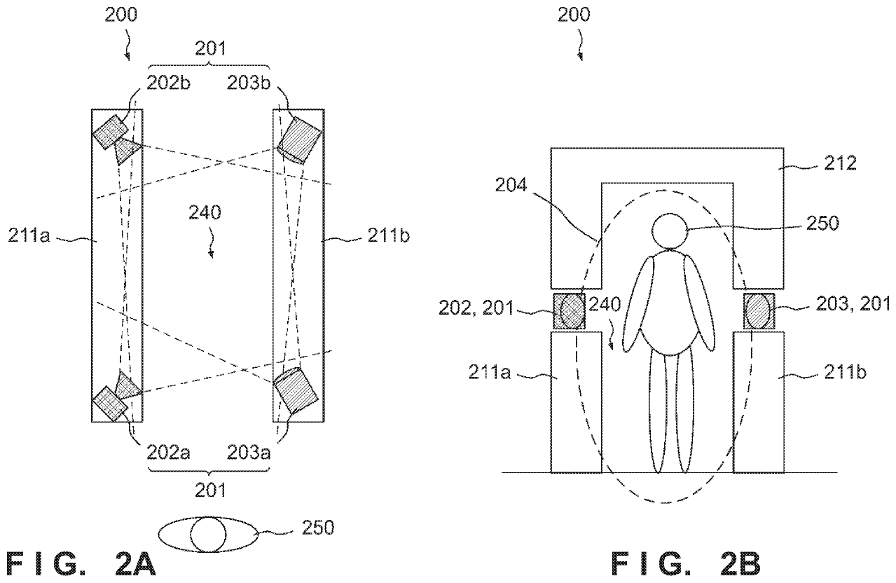

FIG. 2A shows an example in which as the imaging system 201, two sets of illumination units 202 and cameras 203 are arranged on the ticket gate machine 211. As shown in FIG. 2A, illumination units 202a and 202b are arranged on the ticket gate machine 211a, and cameras 203a and 203b are arranged on the ticket gate machine 211b. At this time, as shown in FIG. 2A, the illumination unit 202a and the camera 203a are arranged to illuminate and capture the inner side of the ticket gate from the ticket gate machine 211, and the illumination unit 202b and the camera 203b are arranged to illuminate and capture the outer side of the ticket gate from the ticket gate machine 211. With this arrangement, not only the front side but also the rear side of the inspection object 250 can be captured. At this time, as described above, to efficiently use terahertz waves irradiated from the illumination units 202a and 202b, the illumination unit 202a and the camera 203a may be arranged on the inner side of the ticket gate with respect to the illumination unit 202b and the camera 203b. However, the arrangement of the illumination units 202a and 202b and the cameras 203a and 203b is not limited to this, and they can freely be arranged, as described above. Additionally, as described above, each side surface of the ticket gate machine 211 on the side of the passage 240 may form a reflecting surface that reflects the terahertz wave. That is, each surface of the ticket gate machine 211 on the side of the passage 240 may be made of a metal, or may include a rough surface with an unevenness of about 1/10 of the wavelength of the terahertz wave. Additionally, for example, as shown in FIG. 2B, the ticket gate machine 211 may have a gate-shaped structure including an upper structure 212 for more reflection of the terahertz wave. At this time, each surface of the upper structure 212 on the side of the passage 240 may be made of a metal, or may include a rough surface with an unevenness of about 1/10 of the wavelength of the terahertz wave. When the terahertz wave is reflected or scattered by the surfaces of the ticket gate machine 211, the inspection object 250 is illuminated from various angles, and the quality of images obtained by the camera 203 can be improved.

Additionally, in FIGS. 1A to 2B, the illumination unit 202 and the camera 203 are illustrated large as separated bodies on the ticket gate machine 211 to simplify the description. However, the present invention is not limited to this. The terahertz wave can pass through a material such as a resin. For this reason, a window made of a resin may be provided in a part of the ticket gate machine 211, and the illumination unit 202 or the camera 203 may be arranged in the ticket gate machine 211. As the resin, for example, an appropriate material such as high-density polyethylene or cyclic olefin copolymer can be used. In the following explanation as well, the illumination unit 202 and the camera 203 are illustrated large in the drawings.

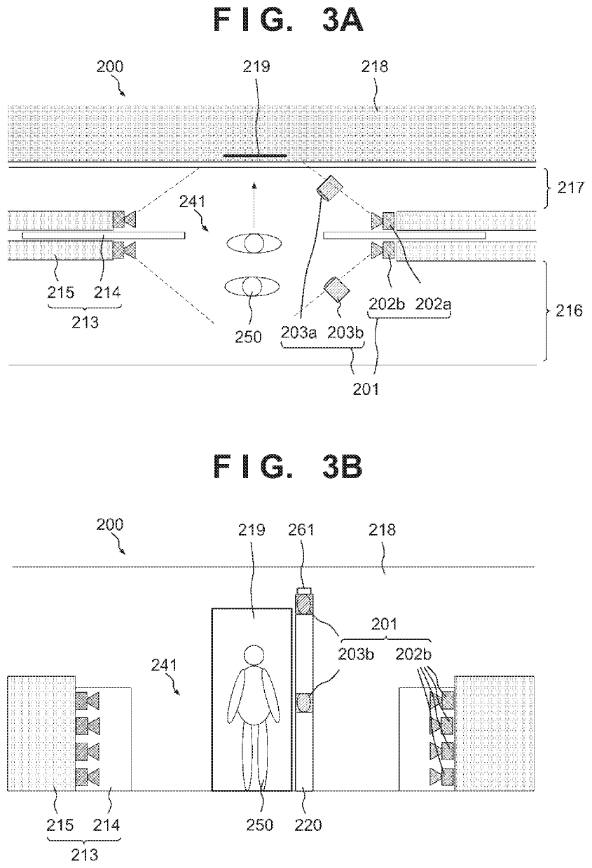

An example in which the imaging system 201 is applied to a partition wall 213 on a platform 216 of a station will be described next with reference to FIGS. 3A and 3B. FIGS. 3A and 3B are a plan view and a front view, respectively, showing an arrangement example of the partition wall 213 in which the imaging system 201 included in the camera system 200 according to the present invention is arranged. The imaging system 201 is arranged to be adjacent to the partition wall 213 configured to partition a platform 216 and a track-side area 217 and including a door portion 214 capable of opening and closing. The partition wall 213 is a so-called platform screen door installed on the platform 216. In this embodiment, the imaging system 201 acquires an image of the inspection object 250 that passes through a passage 241 when the door portion 214 of the partition wall 213 opens.

The imaging system 201 includes the illumination unit 202a and the camera 203a, which are arranged in the track-side area 217. The illumination unit 202a and the camera 203a perform illumination and image capturing of the passage 241 from the track-side area 217 when the door portion 214 opens. In addition, the imaging system 201 includes the illumination unit 202b and the camera 203b, which are arranged in the platform 216. The illumination unit 202b and the camera 203b perform illumination and image capturing of the passage 241 from the platform 216 when the door portion 214 opens. When the illumination unit 202a and the camera 203a, and the illumination unit 202b and the camera 203b are arranged, it is possible to acquire the front- and rear-side images of both the inspection object 250 that gets in a railroad coach 218 via a door 219 and the inspection object 250 that gets off the railroad coach 218 via the door 219. However, the present invention is not limited to this, and only the illumination unit 202a and the camera 203a or only the illumination unit 202b and the camera 203b may be arranged.

Each of the illumination units 202a and 202b may include a plurality of illumination devices, as shown in FIGS. 3A and 3B. As shown in FIGS. 3A and 3B, the illumination units 202a and 202b may be arranged at an end portion, in the direction of opening and closing the door portion 214, of a door pocket portion 215 in the partition wall 213, which stores the door portion 214 when opening the door portion 214. Additionally, as shown in FIG. 3A, when the door portion 214 opens, a part of the door portion 214 is not stored in the door pocket portion 215 in some cases. In this case, the side surface of the part of the door portion 214, which is not stored, may form a reflecting surface that reflects the terahertz wave, like the side surface of the above-described ticket gate machine 211 on the side of the passage 240. This makes it possible to more efficiently use the terahertz waves irradiated from the illumination units 202a and 202b. In addition, the vehicle body of the railroad coach 218 may be used as a reflecting surface that reflects the terahertz wave. When the door portion 214 of the partition wall 213 is opened to form the passage 241, the railroad coach 218 may have arrived. The vehicle body of the railroad coach 218 can be made of a metal. For this reason, the vehicle body of the railroad coach 218 can be used as the reflecting surface that reflects the terahertz wave.

In addition, as shown in FIG. 3B, the cameras 203a and 203b may be attached to a structure such as a pole 220. As the camera 203a or 203b, a plurality of image capturing devices may be used, as shown in FIG. 3B. The cameras 203a and 203b may be arranged, for example, at the height of the waist of the inspection object 250 or at a position higher than the inspection object 250, as shown in FIG. 3B. When the cameras 203a and 203b are arranged at a high position, even if the interval of the inspection objects 250 in the front-and-rear direction is small, the possibility that the images can be acquired one by one becomes higher than in a case in which the cameras 203a and 203b are arranged at a low position. In addition, when the cameras 203a and 203b are arranged at an angle with respect to the passage 241, the possibility of acquiring the front and rear images of the inspection object 250 becomes high.

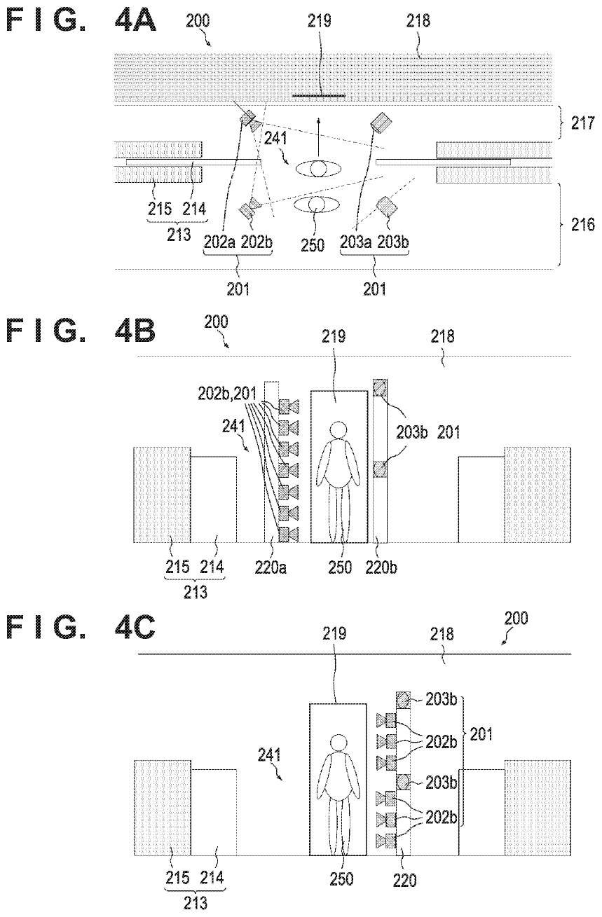

The arrangement of the illumination units 202a and 202b and the cameras 203a and 203b is not limited to the arrangement shown in FIGS. 3A and 3B. For example, as shown in FIGS. 4A to 4C, the illumination units 202a and 202b may be attached to a structure such as the pole 220. At this time, as shown in FIGS. 4A and 4B, the illumination unit 202 and the camera 203 may be attached to separate poles 220a and 220b. Additionally, for example, as shown in FIG. 4C, the illumination unit 202 and the camera 203 may be attached to the same pole 220.

As described above, if the imaging system 201 is used as a surveillance camera, the load of post-processing such as image processing can be reduced by capturing the person who is the inspection object 250 one by one. Hence, the imaging system 201 included in the camera system 200 may be applied to the partition wall 213 installed in a station where a bullet train or a limited express for which persons line up and get in one by one stops. In this case, the width of the door 219 of the railroad coach 218 used for the bullet train or limited express is about 700 mm to 1,000 mm. Hence, in the arrangement shown in FIG. 3A or 4A, the maximum distance between the illumination unit 202 and the camera 203 can be decreased to, for example, about 1,100 mm (inclusive) to 2,000 mm (inclusive). This makes it possible to efficiently use the terahertz wave irradiated from the illumination unit 202. The bullet train or limited express often has a fixed train formation. Hence, the size of the door portion 214 can be changed in accordance with the size of the door 219 of the railroad coach 218. Hence, for example, the distance between the illumination unit 202 and the camera 203 adjacent to the door portion 214 corresponding to the door 219 having a small width (for example, 700 mm), may be, for example, 700 mm (inclusive) to 1,000 mm (inclusive). In this case, the maximum distance between the illumination unit 202 and the camera 203 may be, for example, 850 mm or more.

For example, the imaging system 201 may be applied to, for example, the partition wall 213 in a railroad station of a commuter train or the like. In this case, it may be possible to acquire images of persons one by one except during rush hours. Even in a case in which a plurality of inspection objects 250 simultaneously get in or get off, the inspection objects 250 often line up in two or three lines and get in. Each inspection object 250 can be distinguished by image processing or the like using a processor included in the camera system 200. In a commuter train or the like, the width of a door is about 1,300 mm to 2,000 mm. For this reason, in the arrangement shown in FIG. 3A or 4A, the maximum distance between the illumination unit 202 and the camera 203 may be, for example, 1,500 mm (inclusive) to 3,000 mm (inclusive). The output of the terahertz wave irradiated from the illumination unit 202 may be changed in accordance with the distance between the illumination unit 202 and the camera 203. In this case, the illumination unit 202 whose distance to the camera 203 is longer may irradiate the terahertz wave at an output higher than the illumination unit of a shorter distance.

In some cases, the platform 216 is arranged outdoors. Hence, the imaging system 201 arranged on the platform 216 or the track-side area 217 is readily affected by the external environment. A terahertz wave is readily absorbed by water, and it may be impossible to obtain images with sufficient image quality in a highly humid environment such as a rainfall. Hence, the imaging system 201 may include a sensor 261 configured to detect the external environment, as shown in FIG. 3B. The illumination unit 202 is controlled based on the output of the sensor 261. For example, if the sensor 261 detects the information of humidity, and the humidity is high, the output of the illumination unit 202 to irradiate the terahertz wave may be increased. This can improve the quality of the image acquired by the camera 203.

In addition, for example, the illumination unit 202 or the camera 203 may be attached to the vehicle body of the railroad coach 218. That is, the camera system 200 may include an illumination unit or a camera mounted on the railroad coach 218. In this case, the camera system 200 can include a communication unit between the imaging system 201 arranged in a station and the imaging system including the illumination unit or the camera included in the railroad coach 218.

In addition, for example, the illumination unit 202 and the camera 203 may start operations when the door portion 214 of the partition wall 213 opens. For example, the imaging system 201 may synchronize with the operation of the door portion 214, or may include a sensor configured to detect that the door portion 214 has opened. This can suppress power consumption of the imaging system 201.

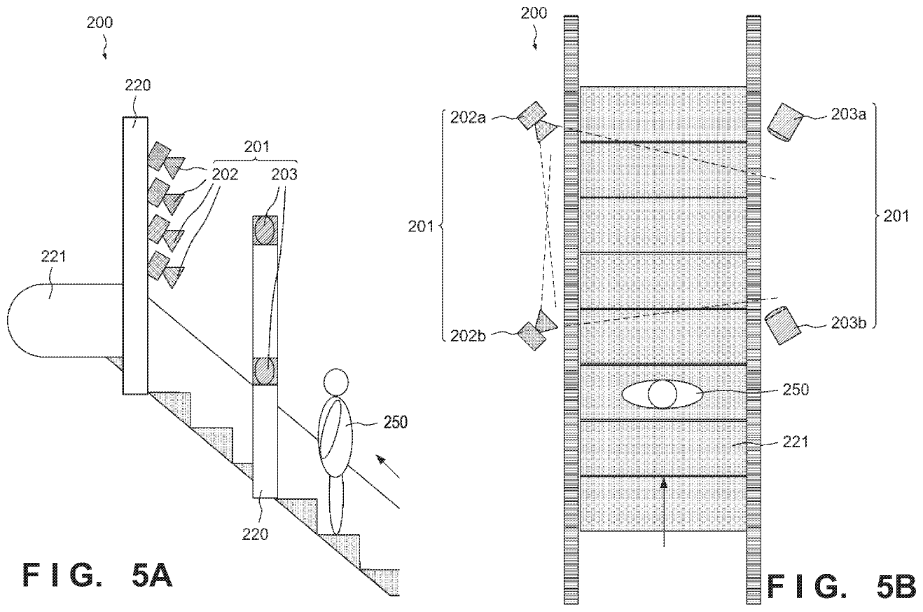

An example in which the imaging system 201 is applied to an escalator 221 will be described next with reference to FIGS. 5A and 5B. FIGS. 5A and 5B are a side view and a plan view, respectively, showing an arrangement example of the escalator 221 in which the imaging system 201 included in the camera system 200 according to the present invention is arranged.

The imaging system 201 is arranged to be adjacent to the escalator 221 to acquire the image of the inspection object 250 that passes through the escalator 221. In the arrangement shown in FIG. 5A, the imaging system 201 includes the illumination unit 202 and the camera 203. The illumination unit 202 may include a plurality of illumination devices, and the camera 203 may include a plurality of image capturing devices. In addition, the illumination unit 202 and the camera 203 may be arranged on separate structures such as the poles 220, as shown in FIG. 5A, or may be arranged on the same structure such as the pole 220. For example, as shown in FIG. 5A, the illumination unit 202 and the camera 203 may be arranged to face a direction opposite to the advancing direction of the escalator 221 and perform illumination and image capturing. This makes it possible to acquire an image of the inspection object 250 on the front side.

For example, as shown in FIG. 5B, the illumination unit 202 and the camera 203 may be arranged in a direction crossing the advancing direction of the escalator 221 while sandwiching the escalator 221. It is possible to obtain the same effects as the illumination unit 202 arranged on the ticket gate machine 211a and the camera 203 arranged on the ticket gate machine 211b described above. In addition, at this time, the illumination unit 202a and the camera 203a may be arranged to face the direction opposite to the advancing direction of the escalator 221 and perform illumination and image capturing, and the illumination unit 202b and the camera 203b may be arranged to face the advancing direction of the escalator 221 and perform illumination and image capturing. This makes it possible to capture not only the front side but also the rear side of the inspection object 250.

As described above, if the imaging system 201 is used as a surveillance camera, it may be advantageous that the person who is the inspection object 250 can be captured one by one. Since the escalator 221 operates at a predetermined speed, the possibility that the image of the inspection object 250 can be acquired one by one is high. Additionally, as shown in FIG. 5A, the escalator 221 includes steps. When the camera 203 is arranged at a high position, the possibility that the image can be acquired one by one becomes higher. On the escalator 221, the inspection objects 250 normally line up in one or two lines. For example, in the escalator 221 on which the inspection objects line up in two lines, the images of the inspection objects 250 may be acquired using two cameras 203. This raises the possibility that the images can be acquired one by one. As a result, the load of image processing at the subsequent stage of the imaging system 201 of the camera system 200 can be reduced.

In addition, as described above, a terahertz wave can pass through a resin or the like. For this reason, the illumination unit 202 or the camera 203 may be embedded in the floor, wall, or ceiling of the portion where the escalator 221 is arranged. For example, the illumination unit 202 may be installed on the deck board of the escalator 221 together with a normal illumination.

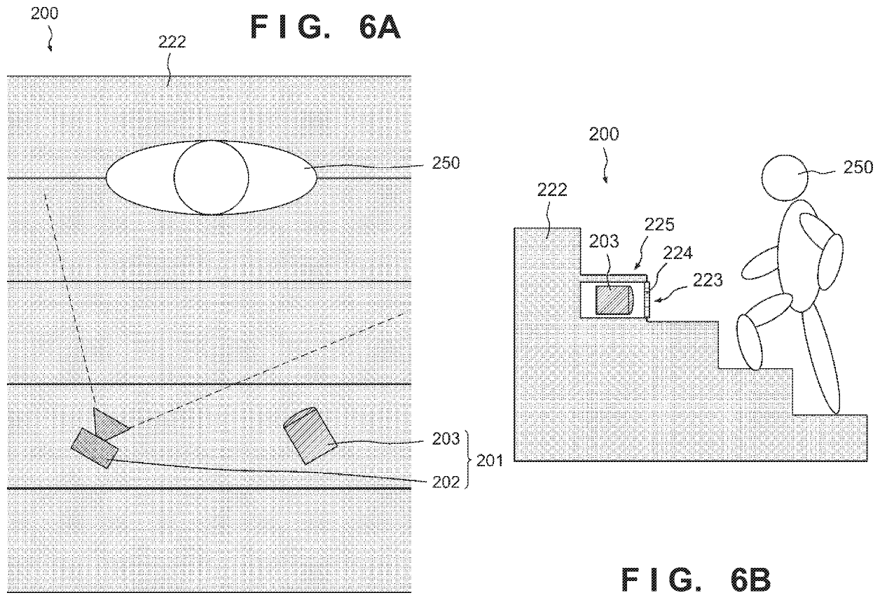

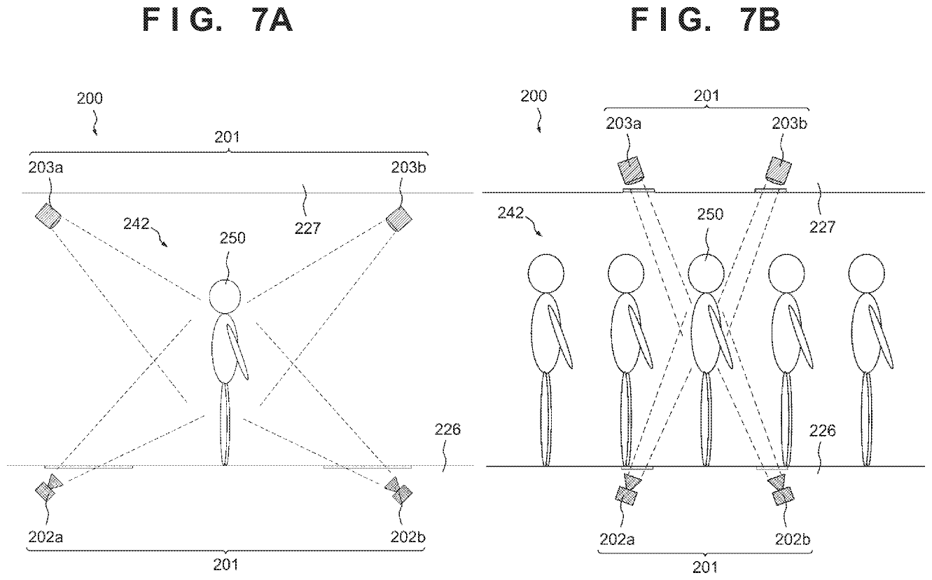

An example in which the imaging system 201 is applied to a staircase 222 will be described next with reference to FIGS. 6A and 6B. FIGS. 6A and 6B are a plan view and a sectional view, respectively, showing an arrangement example of the staircase 222 in which the imaging system 201 included in the camera system 200 according to the present invention is arranged.

The imaging system 201 is arranged in the staircase 222 to acquire the image of the inspection object 250 that passes through the staircase 222. In the arrangement shown in FIGS. 6A and 6B, the imaging system 201 includes the illumination unit 202 and the camera 203. The illumination unit 202 and the camera 203 are embedded in the staircase 222 and arranged to illuminate and capture the inspection object 250 from a window 224 of a riser portion 223 of the staircase 222. As shown in FIGS. 6A and 6B, the illumination unit 202 and the camera 203 can be arranged in the same riser portion 223 of the staircase 222.

Since the person who is the inspection object 250 goes up or down the staircase 222 one by one (or by about two steps), the image of the inspection object 250 can sequentially be acquired from the head (or foot) of the inspection object 250 to the foot (or head).

For the window 224 provided in the riser portion 223 of the staircase 222, various kinds of resins that pass a terahertz wave can be used, as described above. When an appropriate resin material is selected in accordance with the material used for the riser portion 223 or a tread portion 225 of the staircase 222, where the imaging system 201 is not arranged, the imaging system 201 can be made unnoticeable (its existence can be hidden).

An example in which the imaging system 201 is applied to a passage 242 will be described next with reference to FIGS. 7A and 7B. FIGS. 7A and 7B are side views showing an arrangement example of the passage 242 in which the imaging system 201 included in the camera system 200 according to the present invention is arranged.

The imaging system 201 is arranged in the passage 242 to acquire the image of the inspection object 250 that passes through the passage 242. The imaging system 201 includes the illumination unit 202 and the camera 203. At this time, one of the illumination unit 202 and the camera 203 is arranged on a ceiling 227 of the passage 242, and the other of the illumination unit 202 and the camera 203 is embedded in a floor 226 of the passage 242. In the arrangement shown in FIGS. 7A and 7B, the camera 203 is arranged on the ceiling 227 of the passage 242, and the illumination unit 202 is embedded in the floor 226 of the passage 242. However, the present invention is not limited to this. The illumination unit 202 may be arranged on the ceiling 227 of the passage 242, and the camera 203 may be embedded in the floor 226 of the passage 242.

In the arrangement shown in FIGS. 7A and 7B, the illumination unit 202a and the camera 203a are arranged to perform illumination and image capturing from one side of the passage 242 in the passing direction to the other side. In addition, the illumination unit 202b and the camera 203b are arranged to perform illumination and image capturing from the other side of the passage 242 in the passing direction to the one side. This makes it possible to acquire the front- and rear-side images of the inspection object 250 that advances in both the two passing directions of the passage 242. However, the present invention is not limited to this, and only the illumination unit 202a and the camera 203a may be arranged on the passage 242.

FIG. 7B shows an example in which the cameras 203a and 203b are embedded in the ceiling 227 of the passage 242. Accordingly, the cameras 203a and 203b can be made unnoticeable (their existence can be hidden) as compared to a case in which the cameras 203a and 203b are suspended from the ceiling 227, as shown in FIG. 7A. In addition, the optical axis of the illumination unit 202 or the camera 203 is set at a larger angle with respect to the advancing direction of the inspection object 250 in the arrangement shown in FIG. 7B than in the arrangement shown in FIG. 7A. When the angles of the optical axes are set large, as indicated by dotted lines shown in FIGS. 7A and 7B, the possibility that the images of the inspection object 250 can be acquired one by one can become high.

Additionally, in the arrangement shown in FIGS. 7A and 7B, one of the illumination unit 202 and the camera 203 is arranged in the floor 226, and the other is arranged on the ceiling 227. As described above, a terahertz wave can be specularly reflected by the inspection object 250. Hence, when the illumination unit 202 and the camera 203 are arranged to face each other, the terahertz wave irradiated from the illumination unit 202 can readily be detected by the camera 203.

However, the arrangement of the illumination unit 202 and the camera 203 on the passage 242 is not limited to the arrangement shown in FIGS. 7A and 7B. For example, the illumination unit 202 and the camera 203 may be arranged on a side wall of the passage 242 or the like. Both the illumination unit 202 and the camera 203 may be arranged on the floor 226 or the ceiling 227. In this case, the floor 226 or the ceiling 227 on which the illumination unit 202 and the camera 203 are not arranged may function as a reflecting surface that reflects the terahertz wave. For example, the entire interior of the passage 242 except a portion of the illumination unit 202 or the camera 203, which functions as a window to pass the terahertz wave, may function as a reflecting surface that reflects the terahertz wave. Additionally, for example, the illumination unit 202 may include a plurality of illumination devices. In this case, the plurality of illumination devices included in the illumination unit 202 may be arranged in an appropriate number in an appropriate place such as the floor 226, the ceiling 227, or the side wall.

As described above, when the imaging system 201 is arranged in the staircase 222 or the passage 242, a plurality of cameras 203 may be arranged in the widthwise direction of the staircase 222 or the passage 242. Accordingly, the possibility that the image of the inspection object 250 can be captured one by one becomes high. In addition, the imaging system 201 may be arranged in a portion of the staircase 222 or the passage 242, where the width decreases. In the portion of the staircase 222 or the passage 242, where the width decreases, the inspection object 250 can easily line up.

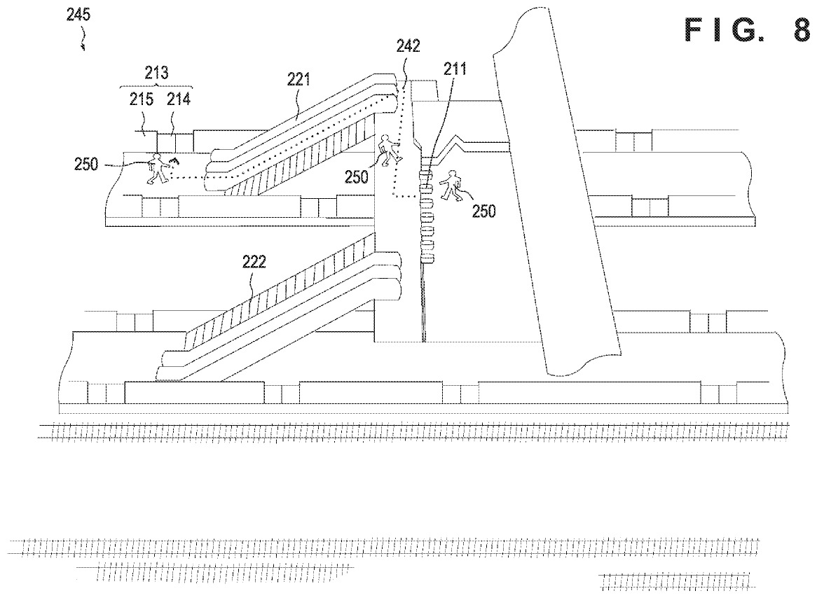

FIG. 8 is a view showing an arrangement example of a station 245 in which the imaging system 201 included in the camera system 200 is arranged. As described above, the imaging system 201 can be arranged on the ticket gate machine 211 at the ticket gate, the passage 242, the escalator 221, the staircase 222, the partition wall 213, or the like. The place to arrange the imaging system 201 including the illumination unit 202 and the camera 203 included in the camera system 200 according to this embodiment is not limited to the above-described places. For example, the imaging system 201 may be arranged in another place such as the entrance or hand wash basin of a restroom, where it is considered that the image of the inspection object 250 can be acquired one by one. The above-described imaging system 201 including the illumination unit 202 and the camera 203 and configured to acquire an image using the terahertz wave may be arranged in a place where a normal surveillance camera using visible light is installed.

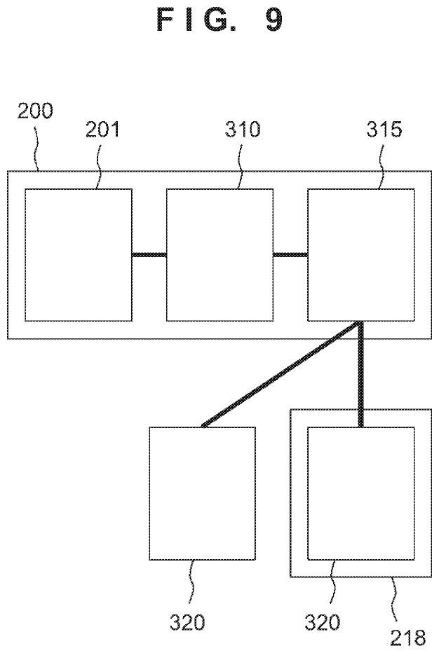

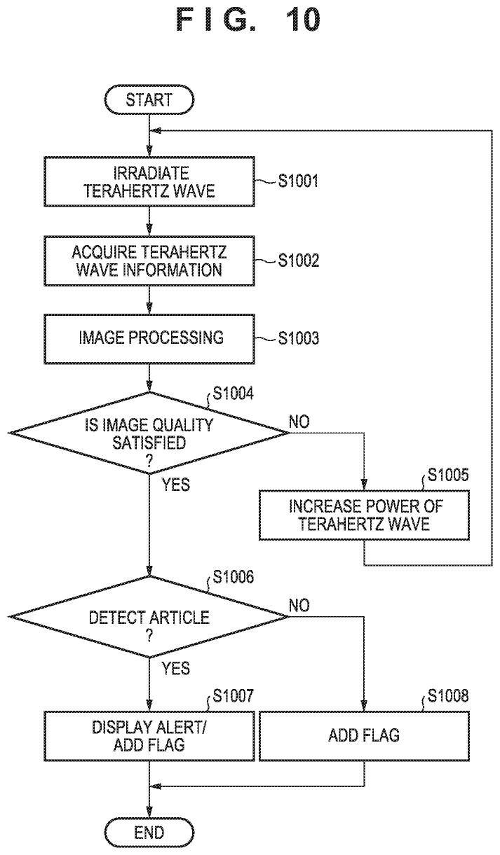

Additionally, the camera system 200 according to this embodiment can monitor the inspection object 250 shown in FIG. 8 in cooperation with the railroad coach 218. FIG. 9 shows an arrangement example of a monitoring system in which the camera system 200 monitors the inspection object 250 in cooperation with the railroad coach 218. The camera system 200 can include the control system 310 and a communication unit 315 in addition to the above-described imaging system 201 arranged in the station. The control system 310 processes a signal output from the imaging system 201. The processing can include deciding a risk concerning the inspection object 250. The processing can include specifying the position of the inspection object 250 having a predetermined risk. Alternatively, the processing can include specifying the seat of the inspection object 250 that has got in the railroad coach 218 based on, for example, a ticket that the inspection object 250 with the predetermined risk has put into the ticket gate machine 211 when passing through the ticket gate machine 211. The control system 310 can be formed by, for example, a PLD (short for Programmable Logic Device) such as an FPGA (short for Field Programmable Gate Array), a processor such as an ASIC (short for Application Specific Integrated Circuit), or a general-purpose or dedicated computer in which a program is installed, or a combination of some or all of them.

The control system 310 can specify the inspection object 250 based on the feature information of the inspection object 250 and correspondence information that associates the feature information with seat information assigned to a passenger having a feature corresponding to the feature information. The feature information can be information extracted by the control system 310 from an image obtained by the imaging system 201. The feature information may be, for example, a feature amount specified based on the shape, the size, and the like of a partial image extracted from an image obtained by the imaging system 201, may be information that specifies the type of a dangerous item, or may be information representing another feature. Alternatively, the feature information may be information representing the above-described risk. Extraction of the partial image from the image acquired by the imaging system 201 can include, for example, extracting a portion having a brightness more than a predetermined brightness. AI (Artificial Intelligence) can be used to extract the feature information. More specifically, AI that has undergone deep learning is installed in the control system 310, and the feature information can be extracted by the AI. For example, information representing a risk in an image captured by the camera 203 appears in a different manner depending on the position and orientation of the camera 203. Hence, deep learning can be executed based on images captured by a plurality of cameras 203.

The control system 310 can transmit the result of the above-described processing to a terminal 320 set in advance via the communication unit 315. The terminal 320 can be carried by, for example, a conductor in the railroad coach 218. The terminal 320 may include a terminal carried by a person other than the conductor in the railroad coach 218, a terminal provided in a security office arranged in a station or the like, and a terminal provided in an administrative body such as a police station.

The imaging system 201 can acquire the image of the inspection object 250 that passes through the ticket gate machine 211 and transmit the obtained image to the control system 310. The control system 310 can decide the risk of the inspection object based on the image received from the imaging system 201. In addition, the control system 310 can extract the feature information of the inspection object from the image received from the imaging system 201.

The control system 310 generates correspondence information that associates the feature information of the inspection object 250 extracted from the image received from the imaging system 201 with seat information read by the ticket gate machine 211. For example, the feature information can be information strongly suggesting holding of a gun, and the seat information can be seat information read by the ticket gate machine 211 from a ticket held by the inspection object 250 that holds the gun. The correspondence information can be transmitted from the control system 310 to the terminal 320 in the railroad coach 218. The feature information may include information that identifies the ID of the inspection object 250 (that is, information that specifies an individual). The imaging system 201 may include a visible light camera, and the ID of the inspection object 250 can be identified from the visible light image of the inspection object 250 or from the visible light image by AI or the like. The visible light image of the inspection object having a predetermined risk can be transmitted to the railroad coach 218 together with the above-described correspondence information and can further be transmitted to the terminal 320. A case in which the image of the inspection object 250 is acquired by the imaging system 201 arranged on the ticket gate machine 211 has been described here. However, tracking of the inspection object 250 may be started or continued based on an image obtained from the imaging system 201 arranged on the partition wall 213, the escalator 221, the staircase 222, or the passage 242. In addition, tracking of the inspection object 250 may be started based on an image obtained by the imaging system 201 arranged on the ticket gate machine 211, and after that, tracking of the inspection object 250 may be continued using a surveillance camera using visible light.

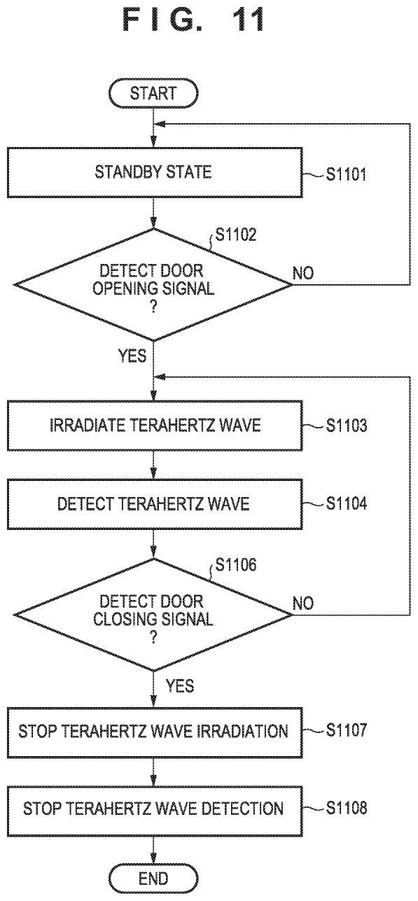

The operation of the camera system 200 will be described next with reference to FIG. 10. FIG. 10 is a flowchart showing an example of the operation of the camera system 200 according to this embodiment. As the arrangement of the camera system 200, the arrangement of the above-described embodiment can be applied. In this embodiment, an operation after an image (to be sometimes referred to as a terahertz image) based on a terahertz wave is acquired by the camera system 200 will be described. In FIG. 10, the camera system 200 evaluates the acquired image, and if the quality is less than desired quality, performs an operation of capturing an image again (recapturing).

First, in step S1001, the illumination unit 202 irradiates the inspection object 250 with a terahertz wave under a desired condition. Next, in step S1002, the camera 203 detects the terahertz wave reflected by the inspection object 250 and acquires information based on the terahertz wave. In step S1003, a control unit performs processing of converting the information based on the terahertz wave into an image. Here, the control unit can be, for example, the control system 310 shown in FIG. 9.

Next, the control unit evaluates the quality of the acquired terahertz image (step S1004). As the evaluation items, items representing whether an appropriate terahertz image according to the inspection object 250 can be acquired, whether an article can be detected from the terahertz image of the image quality, and the like can appropriately be set. In the image quality evaluation, if desired image quality is not satisfied, the camera system 200 performs the operation of step S1005. In step S1005, the control unit supplies, to the illumination unit 202, a control signal for changing the wavelength and increasing the power of the irradiated terahertz wave. The illumination unit 202 performs terahertz wave irradiation (step S1001) again. With the series of operations, a desired article can appropriately be detected.

Note that in the image evaluation, upon determining that the desired image quality can be obtained, the control unit judges the presence and absence of a detected article, and in some cases, the type of the article (step S1006). If an article is detected, the control unit causes a monitor system to display an alert. Alternatively, the control unit outputs an instruction to perform an operation of adding a flag to an article or person of high risk (step S1007). If no article is detected, the control unit may add a flag to the confirmed person of low risk (step S1008).

For the series of operations, the illumination unit 202 and the camera 203 can be used in the following combinations. If there are the illumination unit 202 and the camera 203 used in the first capturing, second and subsequent capturing may be executed using the same illumination unit 202 and the same camera 203. In addition, if there are the illumination unit 202 and the camera 203 used in the first capturing, second and subsequent capturing may be executed using the same illumination unit 202 as in the first capturing and the camera 203 different from that in the first capturing. Furthermore, if there are the illumination unit 202 and the camera 203 used in the first capturing, second and subsequent capturing may be executed using the illumination unit 202 different from that in the first capturing and the same camera as in the first capturing. Furthermore, if there are the illumination unit 202 and the camera 203 used in the first capturing, second and subsequent capturing may be executed using the illumination unit 202 and the camera 203 which are different from those in the first capturing.

Another operation of the camera system 200 will be described next with reference to FIG. 11. In this example, an operation of capturing an image in synchronism with opening and closing of a boarding door of a railroad coach, an entrance door to a carriage, or a platform screen door will be described. FIG. 11 is a flowchart showing an operation of capturing an image in synchronism with a door. In this embodiment as well, the control unit can be, for example, the control system 310 shown in FIG. 9. A description of the same arrangements and operations as in the other embodiments will be omitted. In addition, the door can be, for example, the door 219 of the railroad coach 218 or the door portion 214 shown in FIGS. 3A to 4C.

First, in the camera system 200, the illumination unit 202 is in a standby state (step S1101). At this time, the camera 203 may also be in the standby state. The control unit detects a door opening signal (step S1102). Upon detecting the door opening signal, the control unit supplies a control signal for irradiating the inspection object 250 to the illumination unit 202, and supplies a control signal for capturing the inspection object 250 to the camera 203. The illumination unit 202 starts terahertz wave irradiation in accordance with the control signal from the control unit (step S1103). The camera 203 starts detecting the terahertz wave in accordance with the start of illumination by the illumination unit 202 (step S1104). If the control unit does not detect the door opening signal, the standby state is maintained (step S1101). Upon detecting the door opening signal in step S1102, the control unit is set in a state in which it can always detect the door closing signal (step S1106). Upon detecting a door closing signal in step S1106, the control unit supplies a control signal for stopping terahertz wave irradiation to the illumination unit 202, and supplies a control signal for stopping terahertz wave detection to the camera 203 (steps S1107 and S1108). Here, if the control unit detects the door closing signal, at least one of steps S1107 and S1108 is performed. If the door closing signal is not detected, irradiation and detection of the terahertz wave are continued, and the camera system 200 continues capturing. By the series of operations of monitoring the open and close state of the door, power of the camera system 200 can be saved. In addition, by the series of operations, reliable capturing can be performed at a necessary timing.

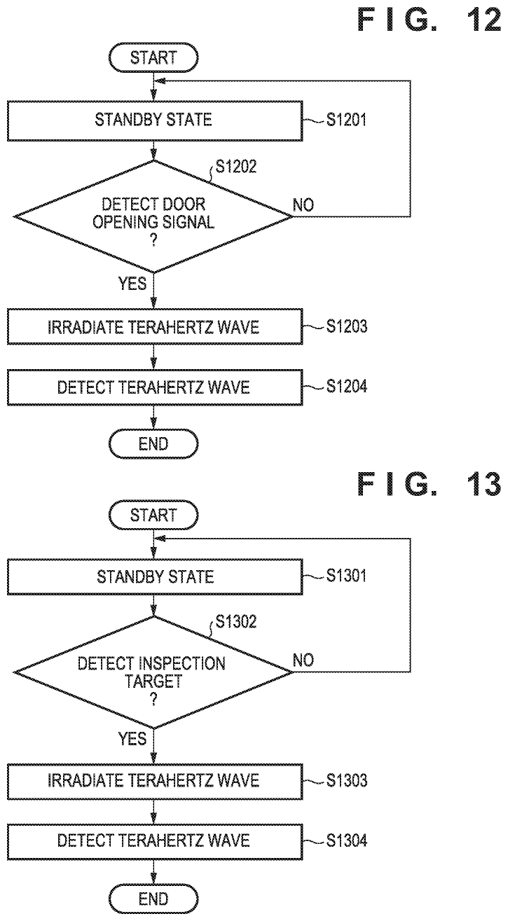

Still another operation of the camera system 200 will be described next with reference to FIG. 12. In this example, a case in which an image is captured in synchronism with the operation of the ticket gate machine 211 will be described. FIG. 12 is a flowchart showing an operation of capturing an image in synchronism with the ticket gate machine 211. In this embodiment as well, the control unit can be, for example, the control system 310 shown in FIG. 9. A description of the same arrangements and operations as in the other embodiments will be omitted.

First, in the camera system 200, the illumination unit 202 is in a standby state (step S1201). At this time, the camera may also be in the standby state. The control unit is in a state in which it can detect a door opening signal that notifies that the door provided in the ticket gate machine 211 opens (step S1202). If the control unit detects the door opening signal, the illumination unit 202 starts terahertz wave irradiation (step S1203). In addition, the camera 203 starts detecting the terahertz wave in accordance with the start of illumination by the illumination unit 202 (step S1204). If the control unit does not detect the door opening signal, the standby state is maintained (step S1201). To detect the door opening signal in step S1202, a signal generated by a ticket put into the ticket gate machine 211, a signal generated by bringing a ticket such as an IC card into contact with the ticket gate machine 211, or a signal for detecting the presence and absence of a ticket such as an IC card using a millimeter wave in the ticket gate machine 211 can be used. When the open and close state of the door of the ticket gate machine 211 is monitored in this way, power can be saved. In addition, by the operation, reliable capturing can be performed.

Still another operation of the camera system 200 will be described next with reference to FIG. 13. In this embodiment, an operation performed in a case in which the sensor 260 described with reference to FIG. 1B is used will be described. FIG. 13 is a flowchart showing the capturing operation in the ticket gate machine 211. In this embodiment as well, the control unit can be, for example, the control system 310 shown in FIG. 9. A description of the same arrangements and operations as in the other embodiments will be omitted.

As described above, the sensor 260 detects the inspection object 250. Here, the sensor 260 may be, for example, a motion sensor using infrared rays or a camera using visible light. First, in the camera system 200, the illumination unit 202 is in a standby state (step S1301). At this time, the camera may also be in the standby state. Next, the inspection object 250 is detected using the sensor 260 (step S1302). The signal from the sensor 260 is sent to the control unit. Upon determining that the inspection object 250 is detected, the control unit supplies a control signal for irradiating the inspection object 250 to the illumination unit 202. The illumination unit 202 starts terahertz wave irradiation in accordance with the control signal from the control unit (step S1303). In addition, the control unit supplies a control signal for capturing the inspection object 250 to the camera 203. The camera 203 starts detecting the terahertz wave in accordance with the control signal from the control unit (step S1304). If the control unit does not determine that the inspection object 250 is detected, the standby state is maintained (step S1301).

By this operation, power can be saved. Additionally, with this operation, reliably capturing can be performed. In this embodiment, a case in which the inspection object 250 is a person has been described. However, the inspection object 250 may be an object. This arrangement can also be applied to the escalator 221 shown in FIGS. 5A and 5B, or the like. If the escalator includes a motion sensor, the sensor can be shared.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2019-047788, filed on Mar. 14, 2019, and 2020-032193, filed on Feb. 27, 2020, which are hereby incorporated by reference herein in their entirety.

What is claimed is:

1. A camera system arranged to form a part of a monitoring system arranged in a place of a facility, where an inspection object lines up, comprising an imaging system configured to acquire an image formed by a terahertz wave reflected by the inspection object.

2. The system according to claim 1, wherein the imaging system includes at least one illumination unit configured to irradiate the terahertz wave, and at least one camera configured to capture an image formed by the terahertz wave.

3. The system according to claim 1, wherein
the facility is a terminal of a movable body, which has a ticket gate,
in the facility, a ticket gate machine that separates an inside of the ticket gate and an outside of the ticket gate and includes a first ticket gate machine and a second ticket gate machine, which are arranged to face each other across a passage, is arranged, and
the imaging system includes a first illumination unit arranged on the first ticket gate machine, and a first camera arranged on the second ticket gate machine.

4. The system according to claim 3, wherein
the imaging system includes a second illumination unit and a second camera, which are configured to acquire an image of the inspection object passing through the passage of the ticket gate machine,
the first illumination unit and the first camera are arranged to perform illumination and capturing of an inner side of the ticket gate from the ticket gate machine, and
the second illumination unit and the second camera are arranged to perform illumination and capturing of an outer side of the ticket gate from the ticket gate machine.

5. The system according to claim 3, wherein
the imaging system includes a second illumination unit arranged on the first ticket gate machine, and a second camera arranged on the second ticket gate machine,
the first illumination unit and the first camera are arranged to perform illumination and capturing of an inner side of the ticket gate from the ticket gate machine, and
the second illumination unit and the second camera are arranged to perform illumination and capturing of an outer side of the ticket gate from the ticket gate machine.

6. The system according to claim 4, wherein the first illumination unit and the first camera are arranged on the inner side of the ticket gate with respect to the second illumination unit and the second camera.

7. The system according to claim 3, wherein a side surface of the ticket gate machine on a side of the passage forms a reflecting surface configured to reflect the terahertz wave.

8. The system according to claim 3, wherein the ticket gate machine has a gate-shaped structure that covers the passage of the ticket gate machine.

9. The system according to claim 2, wherein
the facility is a terminal of a movable body, which has a ticket gate,
the terminal is a station, and
the imaging system is arranged to be adjacent to a partition wall configured to partition a platform and a track-side area and including a door portion capable of opening and closing, and acquires an image of the inspection object passing through a passage when the door portion opens.

10. The system according to claim 9, wherein a width between the illumination unit and the camera configured to acquire an image of the inspection object passing through the passage when the door portion opens is 700 mm (inclusive) to 3,000 mm (inclusive).

11. The system according to claim 9, wherein
the imaging system includes a third illumination unit and a third camera, which are arranged in the track-side area, and
the third illumination unit and the third camera perform, from the track-side area, illumination and capturing of the passage when the door portion opens.

12. The system according to claim 9, wherein
the imaging system includes a fourth illumination unit and a fourth camera, which are arranged on the platform, and
the fourth illumination unit and the fourth camera perform, from the platform, illumination and capturing of the passage when the door portion opens.

13. The system according to claim 11, wherein the third illumination unit is arranged at an end portion, in a direction of opening and closing the door portion, of a door pocket portion in the partition wall, which stores the door portion when opening the door portion.

14. The system according to claim 9, wherein
as for the door portion, when the door portion opens, a part of the door portion is not stored in a door pocket portion in the partition wall, which stores the door portion when opening the door portion, and
a side surface of the part forms a reflecting surface configured to reflect the terahertz wave.

15. The system according to claim 2, wherein to acquire an image of the inspection object passing through an escalator, the imaging system is arranged to be adjacent to the escalator.

16. The system according to claim 15, wherein
the imaging system includes a fifth illumination unit and a fifth camera, and
the fifth illumination unit and the fifth camera are arranged in a direction crossing an advancing direction of the escalator while sandwiching the escalator.

17. The system according to claim 16, wherein
the imaging system includes a sixth illumination unit and a sixth camera,
the fifth illumination unit and the fifth camera are arranged to perform illumination and capturing in the advancing direction of the escalator, and
the sixth illumination unit and the sixth camera are arranged to perform illumination and capturing in a direction opposite to the advancing direction of the escalator.

18. The system according to claim 2, wherein to acquire an image of the inspection object passing through a staircase, the imaging system is arranged on the staircase.

19. The system according to claim 18, wherein
the imaging system includes a seventh illumination unit and a seventh camera, and
the seventh illumination unit and the seventh camera are embedded in the staircase and arranged to perform illumination and capturing from a riser portion of the staircase.

20. The system according to claim 19, wherein the seventh illumination unit and the seventh camera are arranged in the same riser portion of the staircase.

21. The system according to claim 2, wherein to acquire an image of the inspection object passing through a passage, the imaging system is arranged on the passage.

22. The system according to claim 21, wherein
the imaging system includes an eighth illumination unit and an eighth camera, and
one of the eighth illumination unit and the eighth camera is arranged on a ceiling of the passage, and the other of the eighth illumination unit and the eighth camera is embedded in a floor of the passage.

23. The system according to claim 22, wherein
the imaging system includes a ninth illumination unit and a ninth camera,
one of the ninth illumination unit and the ninth camera is arranged on the ceiling of the passage, and the other of the ninth illumination unit and the ninth camera is embedded in the floor of the passage,
the eighth illumination unit and the eighth camera are arranged to perform illumination and capturing from one side of the passage to the other side in an advancing direction, and
the ninth illumination unit and the ninth camera are arranged to perform illumination and capturing from the other side to the one side of the passage in the advancing direction.

24. The system according to claim 2, wherein
the imaging system further comprises a sensor configured to detect the inspection object, and
the illumination unit is controlled based on an output of the sensor.

25. The system according to claim 3, wherein
the imaging system further comprises a sensor configured to detect the inspection object,
the sensor is arranged in the ticket gate machine, and
the illumination unit is controlled based on an output of the sensor.

26. The system according to claim 3, wherein the illumination unit is controlled based on an open and close state of a door provided in the ticket gate machine.

27. The system according to claim 9, wherein the illumination unit is controlled based on an open and close state of the door portion.

28. The system according to claim 1, further comprising a control system configured to perform processing of a signal output from the imaging system,
wherein the processing includes judging whether an image according to the inspection object has been obtained, and
recapturing is performed if the image according to the inspection object has not been obtained.

29. The system according to claim 1, further comprising a control system configured to perform processing of a signal output from the imaging system,
wherein the processing includes deciding a risk concerning the inspection object.

30. The system according to claim 29, wherein the processing includes specifying a position of the inspection object having a predetermined risk.

31. The system according to claim 30, wherein the processing includes specifying a seat of the inspection object having the predetermined risk.

32. The system according to claim 31, wherein the control system specifies the seat of the inspection object based on feature information of the inspection object and correspondence information that associates the feature information with seat information assigned to a passenger having a feature corresponding to the feature information.

33. The system according to claim 32, wherein the feature information is information extracted from the image captured by the imaging system.

34. The system according to claim 29, wherein the control system transmits a result of the processing to a terminal set in advance.

35. A facility including a camera system, wherein the camera system arranged to form a part of a monitoring system arranged in a place of a facility, where an inspection object lines up, comprises an imaging system configured to acquire an image formed by a terahertz wave reflected by the inspection object.
